(19) United States
(12) Patent Application Publication
(10) Pub. No.: US 2007/0138762 A1
(43) Pub. Date: Jun. 21, 2007

(54) Anti-vibration and stabilizer trailer hitch apparatus and system

(76) Inventor: Dan L. Dietz, Houston, TX (US)

Correspondence Address: TUMEY, L.L.P., P.O. BOX 22188, HOUSTON, TX, 77227-2188, US

(21) Appl. No.: 11/311,507

(22) Filed: Dec. 19, 2005

(51) Int. Cl. B60D 1/04

(52) U.S. Cl. 280/506

(57) ABSTRACT

A trailer hitch comprises a combined locking bar and stabilizing bolt to further secure a trailer hitch connection and reduce vibrations during a towing operation. The stabilizing bolt is positioned on a trailer at a location that is not aligned with openings in the trailer hitch. This misalignment prevents the stabilizing bolt from being inserted into the openings for the locking bar.

### FIELD OF THE INVENTION

This invention relates to a trailer hitch attached to a motor vehicle and in particular to an improved trailer hitch for attaching and towing various trailers that transport recreational and industrial items. The improved trailer hitch provides a more secure attachment of the trailer to the motor vehicle such that vibrations at the trailer hitch are substantially reduced.

### BACKGROUND OF THE INVENTION

People who live and work in both urban and rural areas often find themselves with the desire to travel. Many times this travel includes taking their recreational toys with them. They drive to secluded areas, where they can just relax. Others, desiring a more mobile lifestyle, have turned a trailer into their home. One challenge is, how to get their recreational toys (boats, campers, trailers, and the like) from their busy lives to their different recreational locations. Much of this equipment is towed on trailers.

Pick-up trucks are often used to tow trailers. This towing process creates a need for a towing hitch, which can be affixed, to the bed of a pick-up truck (other motor vehicle). The towing hitch needs to be able to both accommodate the pulling forces to which the trailer is exposed when traversing uneven terrains, and provide a latching mechanism, which is both easy to operate as well as safe and reliable. Further, the hitch should be removable so that the truck bed can be freed of obstruction.

To address the problem of traveling over uneven terrain with a trailer attached to a towing vehicle, it is recognized that the hitch head should be allowed to tilt fore and aft, as well as side-to-side pivoting. The prior art has numerous examples of mechanisms to allow such tilting, most by a gimble arrangement. Allowing this movement reduces the strain placed on the latching mechanism of the hitch. Such movement however can create its own wear-and-tear on the tilting mechanism itself, creating additional repair and replacement costs. A need is therefore identified for a fifth wheel hitch assembly for coupling a trailer to a towing pick-up truck which allows for two degrees of movement of the head assembly, while at the same time reducing the friction caused by such movement.

In addition to allowing the head assembly to tilt, the hitch assembly must effectively hold the kingpin of the trailer. When the towing vehicle comes to a stop, the trailer will continue to move forward, until it is interfered with by the trailer hitch. When the kingpin moves forward and is not completely surrounded by the latching mechanism, it will create a jolt along with a loud and disturbing sound. Moreover, the kingpin will wear on the unsupported area of the latching mechanism.

Finally, the entire hitch assembly must not only be easily removable from the towing vehicle, but also must be easily adjustable on the truck bed of the towing vehicle. Fifth wheel hitches are typically bolted to the bed of the towing vehicle above its rear axle. However, when the trailer must be maneuvered in tight spaces, it is useful to be able to adjust fore/aft the location of the hitch assembly to a position nearer to the pickup's tailgate.

A typical trailer hitch connection comprises at least two components. One component attaches to the motor vehicle that will perform the towing function. The other piece attaches to the trailer that contains the item to be transported. Trailer hitch connections are usually designed in a male/female arrangement. In this arrangement, one component is inserted into the other component to form the connection.

These male/female connections can also be of various designs. One conventional design is a ball hitch attached to the motor vehicle as the male component. A hitch having a convex opening approximately the same diameter as the ball. In operation, the trailer hitch with the female design comes down over the male trailer hitch that is attached to the motor vehicle. The weight of the cargo trailer forces the trailer pieces together thereby securing the trailer to motor vehicle via the connected trailer hitch.

Other trailer designs require the insertion of one trailer component into the other trailer component. As shown in U.S. Pat. No. 6,129,371 a square shaped trailer connection has one component inserted into the other component. The design can be such that the components fit tightly together and are firmly secured. This conventional design can also have a pin that extends to holes in both trailer components to further secure and lock the components together. At the insertion, a pair of holes in the trailer components are aligned thereby creating a path through which to extend the pin.

U.S. Pat. No. 6,701,913 and U.S. Application 20040112369 both to LeDuc et al. describe an apparatus that is selectively attachable to a vehicle, for transporting a cooking device and positioning the cooking device in a desired orientation for cooking that also permits access to the vehicle. The apparatus includes a hitch insertion member for insertion into a trailer hitch, a support arm attached to the hitch insertion member, a swing arm attached to the support arm with a locking hinge assembly, a pedestal attached to the swing arm, and a cooking device, for example a barbeque, that is attached to a column that is inserted into the pedestal and that can rotate in the pedestal. The locking hinge assembly has a plurality of locking holes for selective alignment with an angle-securing hole in the support arm for locking the swing arm at a selected angle in relation to the support arm by placing an angle-locking bar into the aligned holes.

The configurations in LeDuc illustrate a trailer hitch at the motor vehicle that has only a locking bar securing the trailer hitch to the vehicle. This locking bar has some looseness to enable easier insertion and withdrawal of the bar. However, with a load such the one illustrated the stress on the bar along with the natural looseness of the bar will cause the bar to vibrate. Over time, these vibrations can weaken the locking bar and ream out the opening through which the locking bar extends. These occurrences will create greater vibrations and a further reaming of the opening and weakening of the locking bar.

There remains a need for a trailer hitch apparatus that can reduce the amount of vibration that occurs in a trailer hitch connection.

### SUMMARY OF THE INVENTION

It is an objective of the present invention to provide an apparatus and system to reduce vibrations in a trailer hitch connection.

It is a second objective of the present invention to provide a locking bar and stabilizer bolt combination to stabilize a trailer hitch connection.

It is a third objective of the present invention to provide a locking bar and stabilizer bolt combination on a hitch connection to stabilize the hitch connection when the motor vehicle is moving.

The system of the present invention comprises a first trailer hitch component that is secured to a motor vehicle. This first trailer hitch component has a hollow center that can receive a complementary second trailer hitch component that is secured to some load. This second trailer hitch is inserted into the hollow center of the first trailer hitch. This insertion creates an outer (first) trailer component and an inner (second) trailer component. Each trailer hitch component openings that can be aligned such that a locking bar can be inserted through the series of aligned openings to secure the trailer hitch components to each other and thereby secure the load to the motor vehicle. The first component further comprises a bolt that is inserted into an additional opening in the outer trailer hitch component. The additional opening being positioned at location on the trailer hitch component that is offset from the initial component opening. The insertion of the bolt extends through the opening and contacts the inner trailer hitch in order to further stabilizer the trailer hitch connection.

### DESCRIPTION OF THE DRAWINGS

FIG. 1 is a view of the trailer hitch component attached to a motor vehicle for engaging a load and attaching that load to the motor vehicle.

FIG. 2a is a view of a locking bar for insertion into the trailer hitch to secure the trailer and load.

FIG. 2b is a view of a pin for insertion into the locking bar to secure the locking bar through the trailer hitch component.

FIG. 3 is a view of the trailer hitch component of a motor vehicle engaging a hitch component from a load attached to the motor vehicle.

FIG. 4a is a view of the trailer hitch component of the present invention containing stabilizing bolts.

FIG. 4b is a view of the stabilizing bolt used to stabilize a trailer hitch connection.

FIGS. 5a and 5b are embodiments of trailer hitch extension components capable of engaging a load and having stabilizing bolts and openings to accommodate the insertion of a locking bar.

FIG. 6 is an illustration of the engagement of a trailer hitch component attached to a motor vehicle with a trailer hitch component attached to a load.

FIG. 7 is a view of a combination of the locking bar and stabilizer bar engaging a trailer hitch component.

FIG. 8 is an illustration of a trailer hitch system of the present invention comprising a combination of locking bars and stabilizing bolts.

### DETAILED DESCRIPTION OF THE INVENTION

The present invention provides a trailer hitch apparatus and system that reduces the amount of vibration that occurs at the engagement of the trailer hitch of a motor vehicle with trailer hitch of a load. The reduction of vibration at this junction will improve the ability to control the movement of the load during towing operations. This vibration reduction will also reduce the amount of stress on the locking bar. The stress on the locking bar could cause the bar to vibrate and thereby ream out the opening in the trailer hitch through which the locking bar extends. This reaming action can enlarge the openings and increase the amount of vibration as a result of the reamed out opening.

FIG. 1 shows a typical trailer hitch 10 that is attached to a motor vehicle. This type of trailer hitch has a generally rectangular shape with four sides. The sides can be parallel right and left sides 12 and parallel top and bottom sides 14. The trailer hitch 10 has a hollow center 16 that can receive the trailer hitch connected to a load. The trailer hitch end at the opening of the hollow center can have a flanged end 18. An opening 20 can facilitate the insertion of a locking bar.

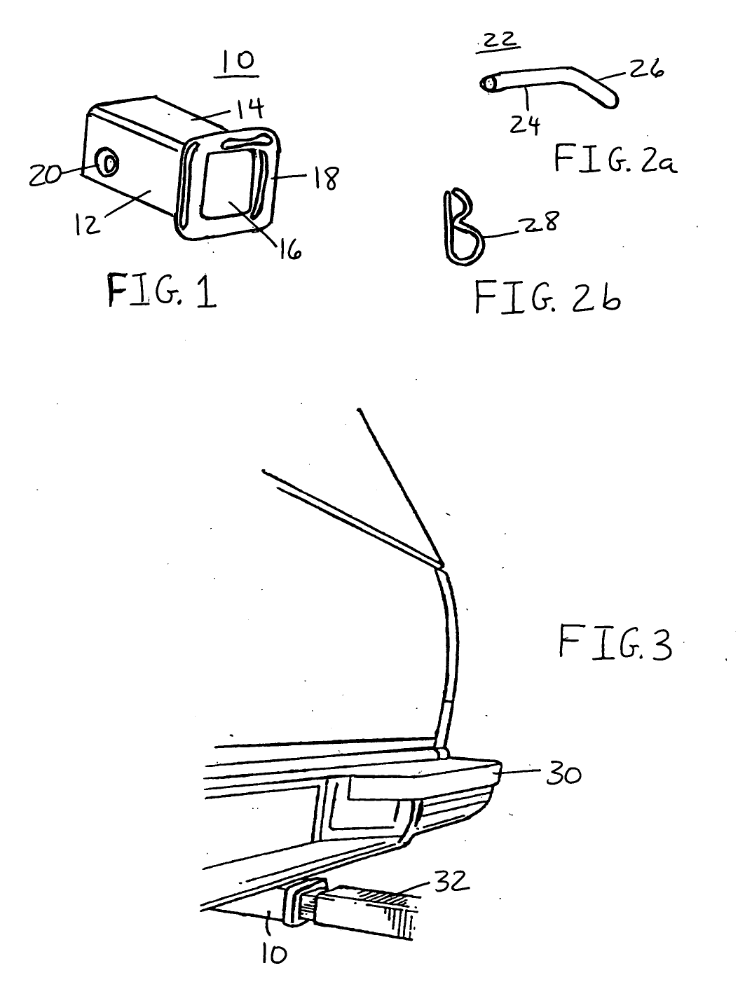

FIG. 2a shows a typical locking bar 22 that is inserted into the opening 20 of the trailer hitch. The bar can be solid with a two a direction configuration. The longer section of the bar 24 can be inserted into the trailer hitch. The shorter section 26 extends in a direction different from the longer section 24 in order to keep the locking bar from slipping completely through trailer hitch. FIG. 2b shows a locking pin 28 that extends through an opening in the longer section 24 of the locking bar 22. This locking pin secures the locking bar in the trailer hitch.

FIG. 3 is a view of the trailer hitch component of a motor vehicle engaging a hitch component from a load attached to the motor vehicle. A motor vehicle 30 has attached to it a trailer hitch 10. A second trailer hitch 32 is inserted into trailer hitch 10 to attach the load to the motor vehicle. Trailer hitch 32 is inserted into trailer hitch 10 such that an opening in trailer hitch 32 is aligned with opening 20 of the trailer hitch 10. The alignment of openings in hitches 10 and 32 are necessary in order to insert the locking bar entirely through both trailers. As previously described, once the locking bar 22 extends completely through both trailer hitches, the locking pin 28 is inserted through the locking bar to secure the engagement of the trailer hitches 10 and 32.

Although the arrangement illustrated in FIG. 3 is a standard configuration for towing items. This configuration uses only the locking bar and the sides of the trailer hitches to secure the engagement of the trailer hitches. Because the fit of the trailers has to loose enough in order to allow for easy insertion and withdraw of trailer hitch 32 into hitch 10, this looseness can create some vibration during travel.

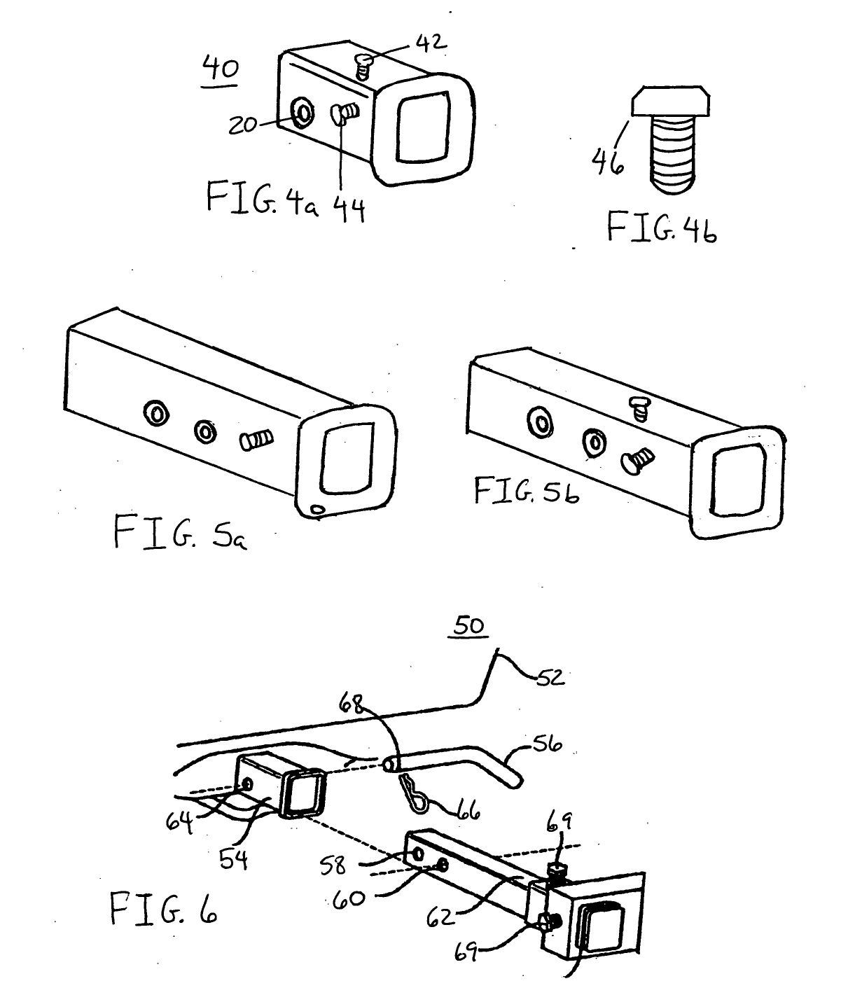

FIG. 4a is a view of the trailer hitch component 40 of the present invention containing stabilizing bolts. This trailer hitch is similar to the one described in FIG. 1, with the exception that stabilizing bolts 42 and 44 are inserted into this hitch. Both bolts extend through openings in the trailer hitch. These openings can be similar to the opening 20 for the locking bar. The preferred positioning of the bolt openings is that the bolt openings are not on the same line as the locking bar opening 20. The bolt openings are designed such that the stabilizing bolts extend through the trailer hitch 10, but come in contact with the wall of the inserted trailer hitch 32. If the bolt openings were on the same line as the locking bar opening 20, the stabilizing bolts could engage one of the multiple holes of the trailer hitch 32. This engagement of the stabilizing bolt through this opening in trailer hitch 32 may not provide a sufficient tightness to reduce vibrations to an acceptable level. When the stabilizer bolt contacts the wall of the trailer hitch 32, the vibration between the trailers is reduced. This embodiment can be implemented with one stabilizing bolt or multiple stabilizing bolts. FIG. 4b is a view of the stabilizing bolt 48 used to stabilize a trailer hitch attachment of the present invention.

FIGS. 5a and 5b are embodiments of trailer hitch extension components capable of engaging a load and having stabilizing bolts and openings to accommodate the insertion of a locking bar. These extensions are similar to trailer hitch 32. As shown, the trailer hitch can be inserted into a trailer hitch 10. This extension can also receive other trailer extensions. The two side holes provide length and alignment flexibility. FIG. 5a has a stabilizing bolt on the same side with the openings locking bar holes. FIG. 5b has stabilizing bolts on the top and side of the extension.

Referring to FIG. 6, shown is a configuration 50 showing the use of an extension 62 such as illustrated in FIGS. 5a and 5b. The trailer hitch apparatus 54 is shown attached to vehicle 52 that is attached to a trailer hitch 54. As discussed above, a hitch locking bar 56 is shown for insertion into hole 58 or hole 60 (and through the corresponding hole on the second side) of the in the collar insertion member 62, and through the hole 64 in the trailer hitch 54 (and the corresponding hole on the opposite side of the trailer hitch 54) to secure the apparatus to the trailer hitch 54. A locking pin clip 66 may be inserted into a hole 68 in the hitch-locking pin 56, to secure the hitch-locking pin 56 to the trailer hitch 52. Bolts 69 secure the collar insertion member 62 to other trailer equipment.

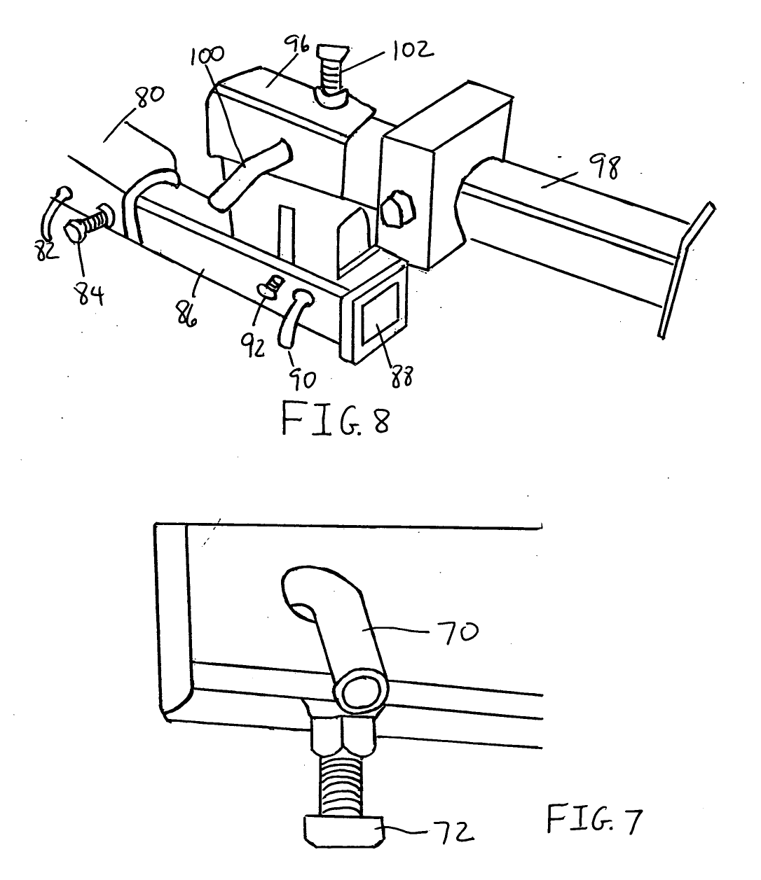

FIG. 7 is a view of a combination of the locking bar and stabilizer bar engaging a trailer hitch component. In this configuration, the long section of the locking bar 70 extends through the trailer hitch as previously described. The stabilizing bolt 72 is positioned under the trailer hitch. This configuration is an example of the flexibility in the positioning of the stabilizing bar on the trailer hitch.

The concept of a locking bar and stabilizing bolt combination to stabilize the trailer hitch and reduce trailer hitch vibration during towing operations can extend to trailer hitch extensions. FIG. 8 illustrates a complex trailer hitch implementing a series of locking bar and stabilizing bolt combinations. As shown, trailer hitch 80 has a locking bar 82 and stabilizing bolt 84. An extension 86 can receive a trailer hitch in opening 88. This extension 86 has a locking bar 90 and a stabilizing bolt 92. Further, extension 96 receives a trailer hitch extension 98. A locking bar 100 and stabilizing bolt 102 secure the extension 98 and extension 96. In this configuration, a load will create a tremendous amount of stress on each connection point.

In a conventional configuration, only locking bars are used. Because there needs to be some looseness with the locking bar of provide for insertion and withdrawal of the locking bars. This looseness of the locking bar is a source of the vibration during the towing process. The stabilizer bolts can be tightened to overcome the looseness that accompanies the locking bar. Both U.S. Pat. No. 6,701,913 and U.S. Application 20040112369 illustrate a series of stabilizing bolts used in combination to secure a trailer hitch. Although the concept of a stabilizing bolt is not new, the use of the stabilizer bolt alone would not be an acceptable approach with regard to the trailer hitch 80. Since the bolts contact the inner trailer hitch but do not extend through the inner hitch, this combination would not lock the trailer hitches together. In U.S. Pat. No. 6,701,913 and U.S. Application 20040112369, these stabilizer bolt combinations were not used in a locking configuration, just a stabilizing configuration. Further, to extend the stabilizing bar through both trailer hitches would not be acceptable. During a towing operation, the threads of the bolts would be ruined.

The locking bar and stabilizing bolt combination of the present invention provides a trailer locking combination that reduces the vibration of the trailer hitch during a towing operation. The trailer hitch and system of the present invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. An anti-vibration and stabilizer trailer hitch comprising:
a trailer hitch element having multiple sides, a front end and a back end, a pair of openings one opening in each of two opposite sides of the trailer hitch element, the openings being equal distance from either front end or back, said trailer hitch element also being hollow at the front end;
a locking bar for insertion through the pair of openings in said trailer hitch element;
a locking pin for extension an opening in said locking bar; and
a stabilizer bolt for insertion into a side of said trailer hitch element, the stabilizer bolt being inserted into stabilizer opening in said trailer hitch element, said stabilizer opening being positioned in a wall of said trailer hitch element at a location that is not aligned on the same plane as the pair of openings in said trailer hitch element.

2. The anti vibration and stabilizer trailer hitch as described in claim 1 further comprising a second stabilizer bolt for extension through an opening in a side of said trailer hitch element.

3. The anti-vibration and stabilizer trailer hitch as described in claim 2 wherein said second stabilizer bolt extends through a different side of said trailer hitch element.

4. The anti-vibration and stabilizer trailer hitch as described in claim 1 wherein said trailer hitch element further comprises a flange at the front end.

5. The anti-vibration trailer hitch as described in claim 1 wherein said trailer hitch element further comprises multiple stabilizer bolts for insertion into various sides of said trailer hitch element, the stabilizer bolts being inserted into stabilizer openings in said trailer hitch element, said stabilizer openings being positioned in a wall of said trailer hitch element at a location that is not aligned on the same plane as the pair of locking pin openings in said trailer hitch element.

6. The anti-vibration trailer hitch as described in claim 2 further comprising a third stabilizer bolt for insertion into a side of said trailer hitch element, the stabilizer bolt being inserted into stabilizer opening in said trailer hitch element, said stabilizer opening being positioned in a wall of said trailer hitch element that is a different wall from said first and second stabilizer bolts and at a location that is not aligned on the same plane as the pair of openings in said trailer hitch element.

7. The anti-vibration trailer hitch as described in claim 1 wherein said trailer hitch element is attached to a motor vehicle.

8. An anti-vibration trailer hitch system comprising:
a first trailer hitch element having multiple sides, a front end and a back end, a pair of openings one opening in each of two opposite sides of the trailer hitch element, the openings being equal distance from either front end or back, said trailer hitch element also being hollow at the front end;
a second trailer hitch element having multiple sides, a front end and a back end, a pair of openings one opening in each of two opposite sides of the trailer hitch element, the openings being equal distance from either front end or back, said second trailer hitch element being insertable into said first trailer hitch element to attach a load to a motor vehicle for towing, said second trailer hitch element being insertable into said first trailer hitch element such that openings in said second trailer hitch can be aligned with openings in said first trailer hitch to create an opening through both trailer hitch elements to enable a locking bar to be inserted into the created opening through the trailer hitch elements.
a locking bar for insertion through the pair of openings in said second trailer hitch element;
a locking pin for extension an opening in said locking bar; and
at least two stabilizer bolts for insertion into a side of said first trailer hitch element, the stabilizer bolts being inserted into stabilizer openings in said first trailer hitch element, said stabilizer openings being positioned in different walls of said trailer hitch element at locations that are not aligned on the same plane as the pair of openings in said first trailer hitch element.

9. The anti-vibration system as described in claim 8 wherein said second trailer hitch element is inserted into said first trailer element such that a pair of openings in said first and second trailer hitch elements are aligned to create a uniformed opening through both trailer hitch elements.

10. The anti-vibration system as described in claim 9 wherein said locking bar is inserted through both pair of aligned openings formed by the insertion of said second trailer hitch into said first trailer hitch.

11. The anti-vibration system as described in claim 10 wherein said stabilizer bolt is inserted through the stabilizer opening in said first trailer hitch element, said stabilizer bolt extended through said first trailer hitch element until said stabilizer bolt contacts said second trailer hitch element to reduce vibration said first and second trailer hitch elements.

12. The anti-vibration trailer hitch system as described in claim 11 further comprising a second stabilizer bolt inserted through a second stabilizer opening in said first trailer hitch element, said stabilizer bolt extended through said first trailer hitch element until said stabilizer bolt contacts said second trailer hitch element to reduce vibration said first and second trailer hitch elements.
